(19) United States
(12) Patent Application Publication
(10) Pub. No.: US 2011/0010205 A1
(43) Pub. Date: Jan. 13, 2011

(54) TRAVEL FARE DETERMINATION AND DISPLAY IN SOCIAL NETWORKS

(75) Inventor: Daniel A. Richards, New York, NY (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/831,412

(22) Filed: Jul. 7, 2010

Related U.S. Application Data
(60) Provisional application No. 61/223,985, filed on Jul. 8, 2009.

(51) Int. Cl. G06Q 10/00; G06Q 30/00; G06Q 99/00

(52) U.S. Cl. 705/5

(57) ABSTRACT

A travel planning, travel fare determination and travel fare display in social networks is disclosed. A contact information retriever retrieves information associated with one or more contacts in a user's social network, and determines locations of the contacts using the retrieved information. The contact information retriever provides the contacts' locations to a booking engine. The booking engine determines travel fares from the user's location to contacts' locations and provides the travel fares to a user interface generator. The user interface generator generates a user interface that displays the contacts' profiles together with travel fares to their respective locations. The user may then use the user interface to proceed with booking travel to a contact's location.

### CROSS REFERENCE TO RELATED APPLICATIONS

This application claims priority to, and claims the benefit of, U.S. Provisional Application Ser. No. 61/223,985 entitled “Travel Fare Determination and Display in Social Networks” filed Jul. 8, 2009 which is hereby incorporated by reference in its entirety.

### FIELD OF INVENTION

This disclosure relates generally to travel planning and the display of travel fares in social networks.

### BACKGROUND

Across the world, social networks are becoming an increasingly popular medium for staying in touch with friends. Social networks are also becoming an effective tool for business networking. As a result of this popularity, social networks such as Facebook operated by Facebook, Inc. of Palo Alto, Calif., and MySpace, produced by MySpace.com of Santa Monica, Calif., have millions of registered users.

A user in a social network may desire to visit one or more contacts within the user's social network. To do so, the user may book travel arrangements either through an online travel agency or a brick-and-mortar travel agent. Regardless of the user's booking method, the user may have to spend time researching cost effective travel fares to a contact's location. Furthermore, if the user intends to visit more than one contact in the social network, the process of identifying appropriate travel fares becomes increasingly tedious.

Therefore, a long-felt need exists for an improved, automated online tool that enables seamless integration between social network contacts and travel planning.

### SUMMARY

A method, system, and computer program product are provided for travel fare determination and display in social networks. In accordance with various embodiments, travel fares from a user's location to locations associated with one or more contacts within or outside the user's social network may be determined and displayed.

In an embodiment, the system obtains a plurality of contacts associated with a social network of a user. The system determines whether location are available for each of the contacts and those with locations information available, a first subset of the plurality of contacts is created. The system determines travel fares to the locations from a user location and automatically displays the travel fares with contact profiles. The system provides provide a first booking option to the user for booking travel to one of the contacts. In response to the user selecting the booking option, the user is provided with a plurality of purchasing options for purchasing travel, e.g., to the location associated with the first contact.

An embodiment includes a computer program product. The computer program product instructs the system to determine travel fares from the user's location to contacts' locations and display the travel fares with the contact profiles.

### BRIEF DESCRIPTION OF THE DRAWINGS/FIGURES

The features and advantages will become apparent from the detailed description set forth below, when taken in conjunction with the drawings, in which like reference numbers indicate identical or functionally similar elements. Additionally, the left-most digit of a reference number identifies the drawing in which the reference number first appears.

FIG. 1 is a block diagram of an exemplary architecture of a system, in accordance with an embodiment.

FIG. 2 is an exemplary user interface, in accordance with an embodiment.

FIG. 3 is an exemplary travel booking interface, in accordance with an embodiment.

FIG. 4 is a flowchart illustrating an exemplary method for generation of a user interface, in accordance with an embodiment.

FIG. 5 is a flowchart illustrating an exemplary method for booking travel, in accordance with an embodiment.

FIG. 6 is a block diagram of an exemplary computer system, in accordance with an embodiment.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the system and method, it should be understood that other embodiments may be realized and that logical and mechanical changes may be made without departing from the spirit and scope. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the methods described herein are implemented using the various particular machines described below. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Embodiments provide a method, system, and computer program product for travel fare determination and display in social networks. In accordance with embodiments, travel fares from a user's location to locations associated with one or more contacts within or outside the user's social network may be determined and displayed.

An “account” or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account code may be distributed and stored in any form of plastic, electronic, magnetic, radio frequency, wireless, audio and/or optical device capable of transmitting or downloading data from itself to a second device. A customer account code may be, for example, a sixteen-digit transaction account code, although each transaction account provider has its own numbering system, such as the fifteen-digit numbering system used by American Express. Each company's transaction account codes comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account code may be, for example, any number or alpha-numeric characters that identify a particular merchant for purposes of card acceptance, account reconciliation, reporting, or the like.

“Entity” may include any individual, consumer, group, business, organization, government entity, social networking user, contact, rewards account holder, transaction account issuer or processor (e.g., credit, charge, etc), merchant, consortium of merchants, account holder, charitable organization, software, hardware, and/or any other entity.

A “user” is any entity that uses the system.

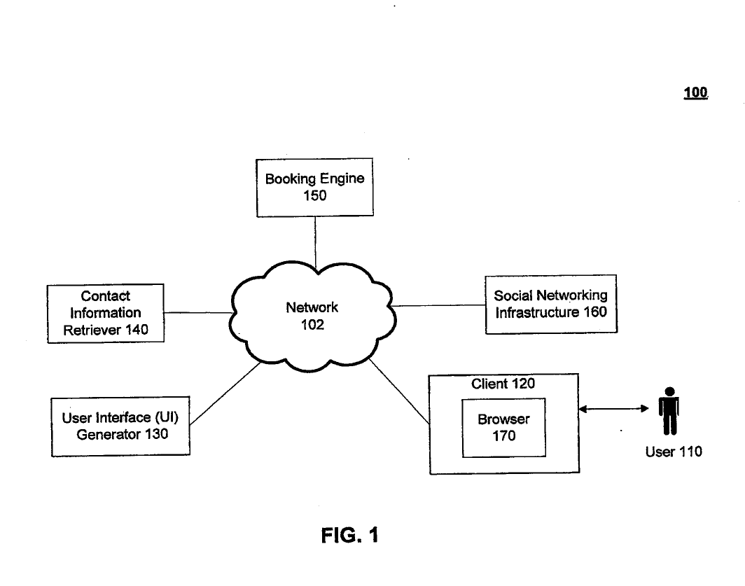

FIG. 1 is a block diagram of an exemplary architecture of a system for travel fare determination and display in social networks. System 100 provides travel fare determination and display in social networks. System 100 includes contact information retriever 140, user interface (UI) generator 130, booking engine 150, and social networking infrastructure 160. System 100 also includes client 120 and network 102. Client 120 further includes browser 170.

In an embodiment, social networking infrastructure 160 includes any system or application that enables social networking. As an example, social networking can include establishing ‘friend’ networks or business networks. In an embodiment, social networking infrastructure 160 is a website that enables social networking. Social networking websites are well known to those skilled in the art and include Facebook, MySpace, Orkut (operated by Google, Inc. of Mountain View, Calif.) and several other web-sites that allow user networking. These examples are purely illustrative and are not intended to limit the disclosure.

In an embodiment, network 102 can include one or more networks, including but not limited to, a local area network, medium-area network, and/or wide-area network, such as, the Internet. Network 102, for example, may be a wired or wireless network that allows contact information retriever 140, UI generator 130, booking engine 150, and social networking infrastructure 160 to communicate with each other. Network 102 can further support world-wide web protocols and services.

In an embodiment, client 120 can be implemented on any client device that can support web browsing. Such a client device can include, but is not limited to, a personal computer, mobile device such as a mobile phone, workstation, embedded system, game console, television, set-top box, or any other computing device that can support web browsing. Such a client device may include, but is not limited to, a device having a processor and memory for executing and storing instructions. Such a client device may include software, firmware, and hardware. The client device may also have multiple processors and multiple shared or separate memory components. Software may include one or more applications and an operating system. Hardware can include, but is not limited to, a processor, memory and graphical user interface display. An optional input device, such as a mouse, may be used. In an embodiment, UI generator 130 provides data to client 120 to display through browser 170.

In an embodiment, browser 170 can communicate with UI generator 130, social networking infrastructure 160, contact information retriever 140 and booking engine 150 over network 102. Browser 170 can further communicate with an input (not shown) to allow a user to input data, to input commands, or to provide other control information to browser 170. User 110 may communicate with browser 170 using client 120. As an example, user 110 may provide an instruction to browser 170 to retrieve and display content from social networking infrastructure 160. Browser 170 may then provide a request for content to social networking infrastructure 160. Social networking infrastructure 160 may respond to the request by providing content back to browser 170 through client 120 over network 102.

In an embodiment, contact information retriever 140 queries social networking infrastructure 160 to obtain information associated with contacts that include user 110's social network and also contacts that may exist outside user 110's social network. As an example, information associated with the contacts can include, but is not limited to, a contact's name, residence address, work address, telephone number, profile image, and an online or offline status. In an embodiment, contact information retriever 140 determines contacts' locations using residence addresses associated with the contacts.

In an embodiment, contact information retriever 140 provides retrieved information associated with the contacts to UI generator 130. The operation of UI generator 130 and an exemplary user interface is described further below.

In an embodiment, booking engine 150 can provide one or more travel fares to UI generator 130 based on user 110's location and contacts' locations. For example, booking engine 150 determines travel fares (e.g. air-fares) from user 110's location to locations (e.g. cities of residence) associated with the contacts and provides the travel fares to UI generator 130.

In an embodiment, UI generator 130 generates a user interface that displays contact profiles with travel fares to their respective locations. As described earlier, the travel fares can be obtained from booking engine 150. As an example, the travel fares can be the least expensive fares that are available to a contact's location.

User 110 may then use the user interface generated by user interface generator 130 to proceed with booking travel to a contact's location. Once booking engine 150 has received an instruction to book travel, booking engine 150 provides user 110 with a list of travel options (e.g. different flight combinations and air-fares that are available to a location.)

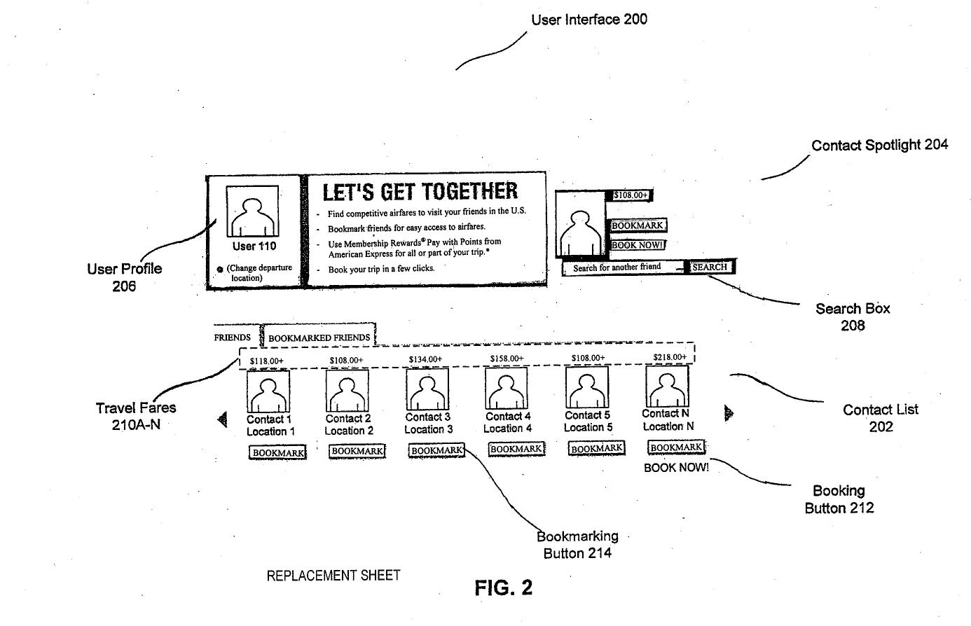

FIG. 2 illustrates an exemplary user interface generated by UI generator 130, according to an embodiment. As shown in FIG. 2, user interface 200 includes contact list 202, contact spotlight 204, user profile 206, search box 208, booking button 212 and bookmarking button 214. As described earlier, UI generator 130 can generate user interface 200 by using data obtained from contact information retriever 140, social networking infrastructure 160 and booking engine 150.

Contact list 202 further includes a plurality of contact profiles 1-N and respective travel fares 210A-N. As an example, contact profiles can include a profile image, a contact name and other information associated with the contact. Travel fares 210A-N associated with contact profiles 1-N can be determined by booking engine 150.

As a purely illustrative example, if contact 1 is in Washington, DC and if user 110 is located in Los Angeles, Calif., user interface generator 130 displays a travel fare between Washington and Los Angeles adjacent to contact 1's profile. The travel fare between Washington and Los Angeles may be retrieved by UI generator 130 from booking engine 150. Furthermore, in an embodiment, travel fares 210A-N can be updated at any configurable frequency.

In an embodiment, user 110 may scroll through contact list 202 to view more contacts in user 110's social network. For example, user 110 can click a right arrow on contact list 202 to scroll contact profiles 1-N in order to display more profiles towards the left hand side of contact list 202. The ability to scroll contact list 202 provides user 110 with an intuitive way of viewing travel fares to all contacts within user 110's social network.

Furthermore, user 110 may also bookmark contacts of interest using bookmarking button 214. Bookmarked contacts, for example, may be displayed using a separate tab in contact list 202.

Contact spotlight 204 displays any one contact with the contact's location and travel fare to the contact's location. In an embodiment, the contact displayed in contact spotlight 204 is selected randomly from the user 110's social network.

User profile 206 displays the profile of user 110. In an embodiment, the profile of user 110 includes a profile image, the name of user 110 and the location of user 110. In an embodiment, the location associated with user 110's profile is used as a departure location for all travel booking options generated by booking engine 150. In an embodiment, user 110 may change the departure location for travel booking.

Search box 208 allows user 110 to search for contacts in user 110's social network.

In another embodiment, user 110 may also enter the name of a location (e.g. Arlington, Va.) and retrieve contacts that are associated with the location. Search results, for example, may be displayed within contact list 202 with contact profile images and travel fares associated with the contacts.

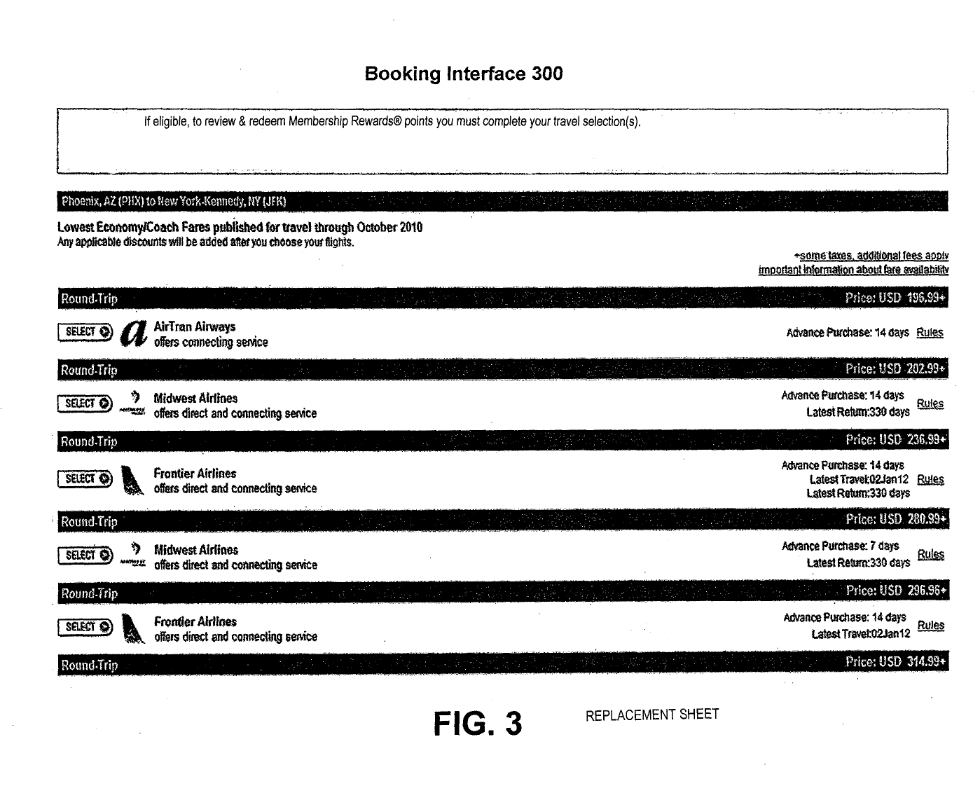

In an embodiment, once user 110 selects booking button 212, user 110 may be navigated to booking interface 300. FIG. 3 shows exemplary booking interface 300, according to an embodiment. In FIG. 3, booking interface 300 is an air travel booking interface. It is to be appreciated that the disclosure is not limited to this example, and booking interface 300 can be used to book other forms of travel. It is also to be appreciated that booking interface 300 acts as an interface between user 110 and booking engine 150.

User 110 can view a plurality of travel options and their respective fares on booking interface 300. Once user 110 has decided to book a travel option (e.g. a particular flight), user 110 can proceed with booking and payment using booking interface 300. In an embodiment, booking interface 300 is able to transmit statistical data associated with travel bookings to booking engine 150. As an example, booking interface 300 can transmit a number of unique users who have proceeded to book and pay for a travel option after browsing booking interface 300. Statistical travel booking data provided by booking interface 300 to booking engine 150 can be used to modify travel options provided to users in subsequent visits to booking interface 300.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, 95/98/2000, XP, Vista, OS2, UNIX, Linux, Solaris, MacOS, etc.) as well as various conventional support software and drivers typically associated with computers. A user may include any individual, business, entity, government organization, software and/or hardware that interact with a system. A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, and/or the like. Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., Alex Nghiem, IT Web Services: A Roadmap for the Enterprise (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

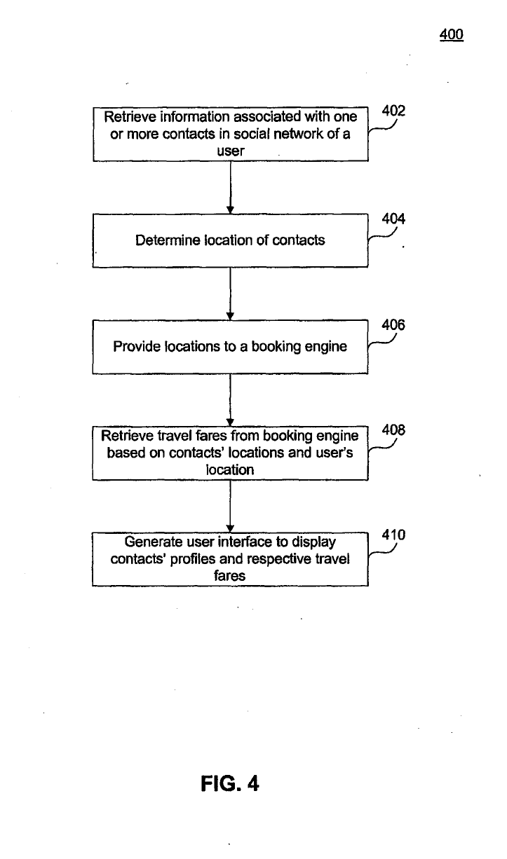

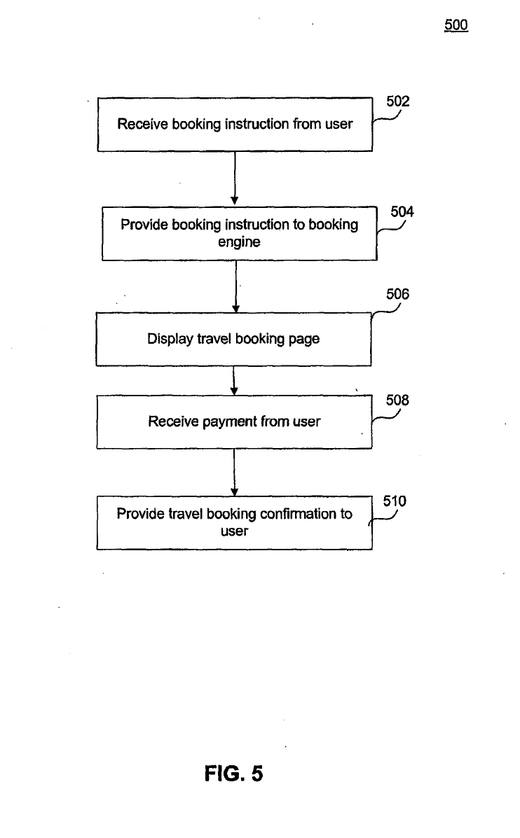

Referring now to FIGS. 4-5 the process flows and screenshots depicted are merely embodiments and are not intended to limit the scope as described herein. For example, the steps recited in any of the method or process descriptions may be executed in any order and are not limited to the order presented. It will be appreciated that the following description makes appropriate references not only to the steps and user interface elements depicted in FIGS. 4-5, but also to the various system components.

Computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

An embodiment includes a contact information retriever to retrieve information associated with one or more contacts in a user's social network, and to determine locations (e.g. cities of residence) of the contacts using the retrieved information. The contact information retriever provides the contacts' locations to a booking engine. The booking engine determines travel fares (e.g. air-fares) from the user's location to the locations associated with the contacts and provides the travel fares to a user interface generator. The user interface generator generates a user interface that displays the contacts' profiles together with travel fares to their respective locations. The user may then use the user interface to book travel to a contact's location.

In an embodiment, the user interface allows the user to scroll through a plurality of contact profiles while displaying the contact's profile image and a travel fare associated with the contact. The user interface further includes a search box that allows the user to search for a contact using the contact's name or even provide a location and retrieve contact profiles associated with the location. Embodiments allow the user to bookmark favorite contacts using the user interface.

FIG. 4 is a flowchart illustrating a method 400 for user interface generation, according to an embodiment.

At step 402, information associated with one or more contacts is retrieved from the social network of a user. As an example, information associated with the contacts can include, but is not limited to, a contact's name, residence address, work address, telephone number, profile image, and an online or offline status.

At step 404, locations associated with the contacts are determined using the information retrieved in step 402. As an example, contacts' locations can be determined using residence addresses associated with the contacts.

At step 406, the locations are provided to a booking engine. At step 408, one or more travel fares, between the user's location and the contacts' locations, are retrieved from the booking engine.

At step 410, a user interface is generated to display contact profiles and respective travel fares to the contacts' locations. An exemplary user interface is described in detail in conjunction with FIG. 2. However, it must be understood that the exemplary user interface described in FIG. 2 does not limit the scope.

FIG. 5 is a flowchart illustrating a method 500 for booking travel using the exemplary booking interface illustrated in FIG. 3.

Method 500 begins at step 502 where a user interface (e.g. the user interface illustrated in FIG. 2) receives a booking instruction from a user. As an example, a user may provide a booking instruction using booking button 212.

At step 504, the booking instruction is provided to a booking engine. At step 506, the booking engine displays a travel booking interface (e.g. the travel booking page illustrated in FIG. 3) to the user. As described earlier, the travel booking interface allows the user to view a plurality of travel options and their respective prices.

At step 508, once a user has decided on a travel option, the booking interface receives payment from the user. As a purely illustrative example, payment can be received using credit card information.

At step 510, the booking interface provides travel booking confirmation to the user.

In this way, embodiments provide for travel fare determination and display in social networks. Further, embodiments display travel fares for multiple contacts simultaneously.

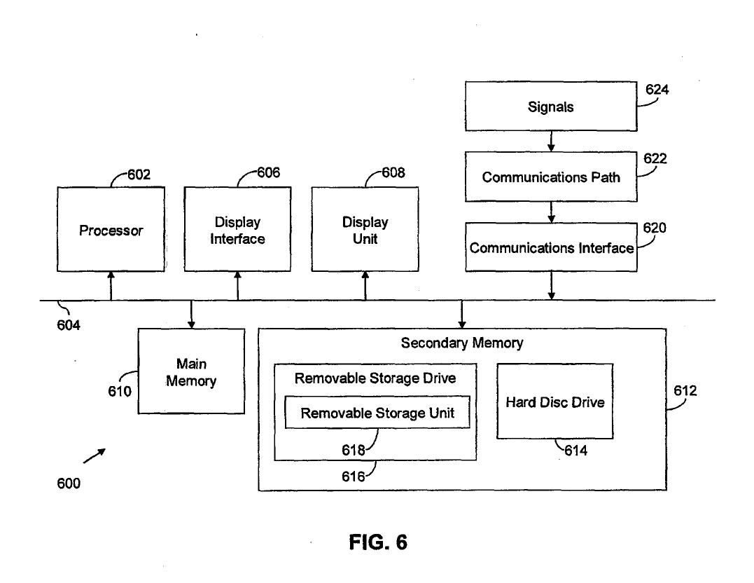

Embodiments, e.g., system 100, user interface 200, booking interface 300, method 400, method 500 or any part(s) or function(s) thereof, may be implemented by using hardware, software or a combination thereof, and may be implemented in one or more computer systems or other processing systems. The manipulations performed are often referred to in terms, such as adding or comparing, which are commonly associated with the mental operations performed by a human operator. This capability of a human operator is unnecessary, or undesirable, in most cases, in any of the operations described herein, which form part. On the contrary, the operations are machine operations. Useful machines for performing the operations include digital computers or similar devices. An example of a computer system 600 is shown in FIG. 6.

Computer system 600 includes one or more processors such as processor 602. Processor 602 is connected to a communication infrastructure 604, for example, a communication bus, a cross over bar, and a network. Various software embodiments are described in terms of this exemplary computer system. After reading this description, it will become apparent to a person skilled in the relevant art(s) how the disclosure can be implemented by using other computer systems and/or architectures.

Computer system 600 may include a display interface 606 that forwards graphics, text, and other data received from communication infrastructure 604 (or from a frame buffer that is not shown) for display on a display unit 608.

Computer system 600 also includes a main memory 610, preferably a random access memory (RAM), and may also include a secondary memory 612. Secondary memory 612 may include, for example, a hard disk drive 614 and/or a removable storage drive 616 representing a floppy disk drive, a magnetic tape drive, an optical disk drive, etc. Removable storage drive 616 reads from and/or writes to a removable storage unit 618 in a well-known manner. Removable storage unit 618 represents a floppy disk, a magnetic tape, an optical disk, etc., which is read by and written to by removable storage drive 616. As will be appreciated, removable storage unit 618 includes a computer-readable storage medium with stored computer software and/or data.

In alternative embodiments, secondary memory 612 may include other similar devices, enabling computer programs or other instructions to be loaded into computer system 600. Such devices may include, for example, a removable storage unit and an interface. Examples of these devices may include a program cartridge and a cartridge interface such as those found in video game devices, a removable memory chip such as an erasable programmable read-only memory (EPROM), or a programmable read only memory (PROM)) and an associated socket, as well as other removable storage units and interfaces that enable software and data to be transferred from the removable storage unit to computer system 600.

Computer system 600 may also include a communications interface 620, which enables software and data to be transferred between computer system 600 and external devices. Examples of communications interface 620 may include a modem, a network interface such as an Ethernet card, a communications port, a Personal Computer Memory Card International Association (PCMCIA) slot, and card. Software and data transferred via communications interface 620 may be in the form of signals 624, which may be electronic, electromagnetic, optical or other signals that are capable of being received by communications interface 620. These signals 624 are provided to communications interface 620 via a communications path 622 (e.g., channel). This communications path 622 carries signals 624 and may be implemented by using a wire or cable, fiber optics, a telephone line, a cellular link, a radio frequency (RF) link, and other communication channels.

In this document, the terms ‘computer program medium’ and ‘computer-readable medium’ are used to generally refer to media such as removable storage drive 616, a hard disk installed in hard disk drive 614, and signals 624. These computer program products provide software to computer system 600. Embodiments are directed at such computer program products.

Computer programs, also referred to as computer control logic, are stored in main memory 610 and/or secondary memory 612. These computer programs may also be received via communications interface 620. Such computer programs, when executed, enable computer system 600 to perform the features, as discussed herein. In particular, the computer programs, when executed, enable processor 602 to perform the features. Accordingly, such computer programs act as the controllers of computer system 600.

In an embodiment where the disclosure is implemented by using software, the software may be stored in a computer program product and loaded into computer system 600 by using removable storage drive 616, hard disk drive 614 or communications interface 620. The control logic (software), when executed by processor 602, causes processor 602 to perform the functions, as described herein.

In another embodiment, the disclosure is implemented primarily in hardware, using, for example, hardware components such as application-specific integrated circuits (ASICs). The implementation of the hardware state machine, to perform the functions described herein, will be apparent to persons skilled in the relevant art(s). In one embodiment, the disclosure is implemented by using a combination of both hardware and software.

In an embodiment, the system obtains a plurality of contacts associated with a social network of a user. For example, a user may be a member of the Facebook® social network and the system determines the user's contacts or “friends” by accessing Facebook (e.g., via an API) or a database associated with Facebook. In an embodiment, the system determines a plurality of contacts by accessing and consolidating information from a plurality of social networks.

The system determines whether locations are available for each of the contacts and those with locations information available, a first subset of the plurality of contacts is created. The system determines travel fares to the locations from a user location and automatically displays the travel fares with contact profiles. The system may determine location information, both for the user and for the contact, in a variety of ways, such as for example, based upon user profile information associated with the social network, from input received from the user, and determining location information received from a user device. In an embodiment, the system uses information available from global positioning systems to determine the location of a user or a contact. In one embodiment, if location information is not available for a contact, the system prompts the user to enter location information to associate with the contact.

The system provides provide a first booking option to the user for booking travel to one of the contacts. For example, the system may indicate that a flight to New York City costs $280 and provides a button for the user to select if the user wishes to purchase a ticket. In response to the user selecting the booking option, the user is provided with a plurality of purchasing options for purchasing travel, e.g., to the location associated with the first contact. In one embodiment, the purchasing options are provided by booking engine 150.

In one embodiment, the system is configured to update the travel fares. For example, the system may provide the user with a refresh option that, when selected, updates the travel fares. In an embodiment, fares are updated automatically, for example, based upon a predetermined rule and/or based upon a timeframe expiring since the travel fares were last updated.

As discussed above in association with contact spotlight 204, in an embodiment, the system selects a contact profile and displays the profile in a separate section of an interface. In various embodiments, the system may select a profile in a variety of ways such as, for example, randomly selecting, selecting based upon a minimum travel fare, selecting based upon a proximity of contact and/or selecting based upon a frequency with which the user interacts with the user via the social network.

In an embodiment, the system may also access loyalty and/or rewards account information of the user and or any of the contacts. Rewards account information may be used to offer fares (e.g., based upon reward point redemption), purchase fares and award points for purchases or other activity. In an embodiment, the system may determine reward account information based upon, e.g., social network profile information, from a third-party datasource, from a service provider, etc. Details regarding loyalty point systems which may be incorporated into various embodiments are disclosed in MR as Currency™ and Loyalty Rewards Systems disclosed in U.S. Patent Application Ser. No. 60/197,296 filed on Apr. 14, 2000; in U.S. patent application Ser. No. 10/708,570 entitled “Geographic Loyalty System And Method” and filed on Mar. 11, 2004; U.S. patent application Ser. No. 10/304,251 entitled “System And Method For The Transfer Of Loyalty Points” filed on Nov. 26, 2002, U.S. Pat. No. 7,398,225 entitled “System And Method For Networked Loyalty Program” filed on Apr. 17, 2001; and, U.S. Pat. No. 7,398,226 entitled “System And Method For Networked Loyalty Program” filed on Nov. 6, 2001, all of which are hereby incorporated by reference in their entirety.

In one embodiment, the system determines that a travel fare can be purchased with user rewards points associated with a user rewards account and a plurality of purchasing options presented by the system includes a rewards points purchasing option. In an embodiment, the system converts the travel fare to a rewards points amount and displays the rewards points amount in the user interface.

In an embodiment, the system enables a user to determine how much it might cost for a user's contact to visit the user. One of skill in the art will appreciate that travel fares are not necessarily symmetric; i.e., roundtrip airfare from Phoenix to New York may be different than roundtrip airfare from New York to Phoenix. Thus, in an embodiment, the system determines airfares based upon travel originating from the contact location and terminating, for example, the user location. The system provides the information to the user and offers to send the information to one or more of the user's contacts.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the system and method have been described as a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computer-based method for travel planning, comprising:
obtaining, by a computer for travel planning, a plurality of contacts associated with a social network of a user;
determining, by the computer, locations associated with a first subset of the plurality of contacts, wherein the plurality of contacts comprises a first contact;
determining, by the computer, travel fares to the locations from a user location associated with the user, wherein the travel fares comprise a first travel fare;
displaying, by the computer, the travel fares with contact profiles; and
providing, by the computer and to the user, a first booking option associated with the first travel fare and the first contact, wherein in response to the user selecting the booking option, the user is provided with a plurality of purchasing options for purchasing travel.

2. The method of claim 1, further comprising determining the user location.

3. The method of claim 1, further comprising determining the user location based upon at least one of user profile information associated with the social network, input received from the user, and location information received from a user device.

4. The method of claim 1, further comprising, in response to the location being unavailable for the first contact, prompting the user for the location for the first contact.

5. The method of claim 1, wherein the social network comprises a plurality of social networks.

6. The method of claim 1, further comprising updating the travel fares.

7. The method of claim 1, further comprising, in response to at least one of a timeframe expiring and receiving a user request, updating the travel fares.

8. The method of claim 1, wherein the each of contact profile in the contact profiles comprises a picture, a name and a location.

9. The method of claim 1, wherein a first purchase option in the plurality of options is associated with the first travel fare.

10. The method of claim 1, further comprising selecting a second contact profile from the contact profiles, wherein the displaying comprises featuring that second contact profile in a separate section of an interface.

11. The method of claim 10, wherein the selecting comprises at least one of randomly selecting, selecting based upon a second travel fare associated with a second contact and selecting based upon a proximity of second location associated with the second contact.

12. The method of claim 1, further comprising determining, a rewards account for at least one of the user, each of the plurality of contacts and the first contact.

13. The method of claim 12, further comprising determining that the first travel fare can be purchased with user rewards points associated with a user rewards account.

14. The method of claim 13, wherein the plurality of purchasing options comprises a rewards points purchasing option.

15. The method of claim 13, further comprising converting the first travel fare to a rewards points amount and displaying the rewards points amount.

16. The method of claim 12, further comprising determining a second subset of the plurality of contacts, wherein each contact in the plurality of contacts is associated with a rewards account.

17. The method of claim 1, further comprising determining a second travel fare from a first location associated with a first contact to the user location and providing an option to send the first contact the second travel fare.

18. The method of claim 17, further comprising determining that the second travel fare may be purchased using a rewards account associated with the first contact.

19. A system comprising:
a network interface associated with a memory and a computer for travel planning;
the computer configured to execute a computer program;
the computer program, when executed by the computer, is configured to perform operations comprising:
obtaining a plurality of contacts associated with a social network of a user;
determining locations associated with a first subset of the plurality of contacts, wherein the plurality of contacts comprises a first contact;
determining travel fares to the locations from a user location associated with the user, wherein the travel fares comprise a first travel fare;
displaying the travel fares with contact profiles; and
providing, to the user, a first booking option associated with the first travel fare and the first contact, wherein in response to the user selecting the booking option, the user is provided with a plurality of purchasing options for purchasing travel.

20. A non-transitory computer-readable medium having computer-executable instructions stored thereon that, if executed by a computer for travel planning, cause the computer to perform operations comprising:
obtaining, by the computer, a plurality of contacts associated with a social network of a user;
determining, by the computer, locations associated with a first subset of the plurality of contacts, wherein the plurality of contacts comprises a first contact;
determining, by the computer, travel fares to the locations from a user location associated with the user, wherein the travel fares comprise a first travel fare;
displaying, by the computer, the travel fares with contact profiles; and
providing, by the computer and to the user, a first booking option associated with the first travel fare and the first contact, wherein in response to the user selecting the booking option, the user is provided with a plurality of purchasing options for purchasing travel.
